(19) United States
(12) Patent Application Publication
(10) Pub. No.: US 2008/0154679 A1
(43) Pub. Date: Jun. 26, 2008

(54) Method and apparatus for a processing risk assessment and operational oversight framework

(76) Inventor: Claude E. Wade, Chester Springs, PA (US)

Correspondence Address: FOX ROTHSCHILD LLP, 100 PARK AVENUE, SUITE 1500, NEW YORK, NY, 10017, US

(21) Appl. No.: 11/982,562

(22) Filed: Nov. 2, 2007

Related U.S. Application Data
(60) Provisional application No. 60/856,523, filed on Nov. 3, 2006.

(51) Int. Cl. G06F 17/00

(52) U.S. Cl. 705/7

(57) ABSTRACT

A method and apparatus providing a linkage between and a measurement of the operational risk exposure to any company within the context of how that company creates value for its customers in the marketplace is presented. That is, the operational risk exposure to an organization is evaluated by looking at the various value creation continuum streams that the organization has, identifying the critical risk points within that value stream, and then assessing the risk of catastrophic incident on the value stream. A likelihood of failure and a worse case scenario are attributed for each one of the individual risk points. Such can be accomplished utilizing a “Monte Carlo” type simulation to determine the probabilities of what the worse case scenario is and what the revenue impact is from that worse case scenario, and what the most likely scenario to occur is and what the revenue impact is on that case scenario. Such numbers can then be aggregated across all of the value streams a company may have to determine what the capital calculation should be for operational risk and what capital should be held against such scenarios. In other words, in such calculations the key risk indicators are linked across the value creation stream.

### PRIOR PROVISIONAL PATENT APPLICATION

The present application claims the benefit of U.S. Provisional Application No. 60/856,523 filed Nov. 3, 2006, the disclosure of which is hereby incorporated by reference.

### FIELD OF THE INVENTION

The present invention is generally directed to a method and apparatus for a processing risk assessment and operational oversight framework, and more particularly, to a reality based framework for cultural change that creates and reinforces a discipline of risk management within the value creation continuum of the business.

### BACKGROUND OF THE INVENTION

Risk is a concept that denotes a potential negative impact to an asset or some characteristic of value that may arise from some present process or future event. In everyday usage, “risk” is often used synonymously with the probability of a loss or threat.

Generally, Risk Management is the process of measuring, or assessing risk and developing strategies to manage it. Strategies include transferring the risk to another party, avoiding the risk, reducing the negative effect of the risk, and accepting some or all of the consequences of a particular risk. Traditional risk management focuses on risks stemming from physical or legal causes (e.g. natural disasters or fires, accidents, death, and lawsuits). Financial risk management, on the other hand, focuses on risks that can be managed using traded financial instruments.

In ideal risk management, a prioritization process is followed whereby the risks with the greatest loss and the greatest probability of occurring are handled first, and risks with lower probability of occurrence and lower loss are handled later. In practice the process can be very difficult, and balancing between risks with a high probability of occurrence but lower loss vs. a risk with high loss but lower probability of occurrence can often be mishandled.

Intangible risk management identifies a new type of risk—a risk that has a 100% probability of occurring but is ignored by the organization due to a lack of identification ability. For example, knowledge risk occurs when deficient knowledge is applied. Relationship risk occurs when collaboration ineffectiveness occurs. Process-engagement risk occurs when operational ineffectiveness occurs. These risks directly reduce the productivity of knowledge workers, decrease cost effectiveness, profitability, service, quality, reputation, brand value, and earnings quality. Intangible risk management allows risk management to create immediate value from the identification and reduction of risks that reduce productivity.

Effective “Operation Risk Management” is cultural, and most efforts at cultural change fail because they are not linked to improving the business' outcomes. Again, ideal risk management minimizes spending while maximizing the reduction of the negative effects of risks, however, most Risk Management initiatives fail to meet benefits because they are disassociated from the value creation continuum of the business.

### SUMMARY OF THE INVENTION

Accordingly, the present invention addresses these problems by introducing a structurally based, blended and integrated approach to quantifying and managing operation risk by a framework hierarchy, that is, a processing risk assessment and operational oversight framework (“PROOF”).

Tactically, this framework supports the development of a business focused operational risk management program designed to quantify operational risk exposure relative to the revenue associated with the value creation continuum and thereby minimize economic capital reserves required by financial institutions. Reducing economic capital reserves allows businesses to put more capital to work towards maximizing shareholder returns and fulfilling the company's fiduciary obligations.

Strategically, this framework establishes a cultural link between effective business execution, improved operational performance and managing risk. The result is a direct quantifiable correlation between the value creation continuum and the risk associated with creating that value.

The present invention, including its features and advantages, will become more apparent from the following detailed description with reference to the accompanying drawings.

### BRIEF DESCRIPTION OF THE DRAWINGS

FIG. 1 is an illustration of the Processing Risk Assessment and Operational Oversight Framework (“PROOF”) pyramidal hierarchy, according to an embodiment of the present invention.

FIG. 2 is an illustration of the first step of the PROOF hierarchy showing a customer value creation continuum, according to an embodiment of the present invention.

FIG. 3 is an illustration of the second step of the PROOF hierarchy showing key performance and risk indicators, according to an embodiment of the present invention.

FIG. 4 is an illustration of the third step of the PROOF hierarchy showing operational event tracking, according to an embodiment of the present invention.

FIG. 5 is an illustration of the fourth step of the PROOF hierarchy showing event trend analysis, according to an embodiment of the present invention.

FIG. 6 is an illustration of the fifth step of the PROOF hierarchy showing scenario analysis, according to an embodiment of the present invention.

FIG. 7 is an illustration of the sixth step of the PROOF hierarchy showing risk based self-assessment, according to an embodiment of the present invention.

FIG. 8 is an illustration of the seventh step of the PROOF hierarchy showing risk scoring, according to an embodiment of the present invention.

FIG. 9 is an illustration of major events taking place via the PROOF hierarchy, according to an embodiment of the present invention.

FIG. 10 is an illustration of an example of a generic mortgage securitization process, according to an embodiment of the present invention.

### DETAILED DESCRIPTION

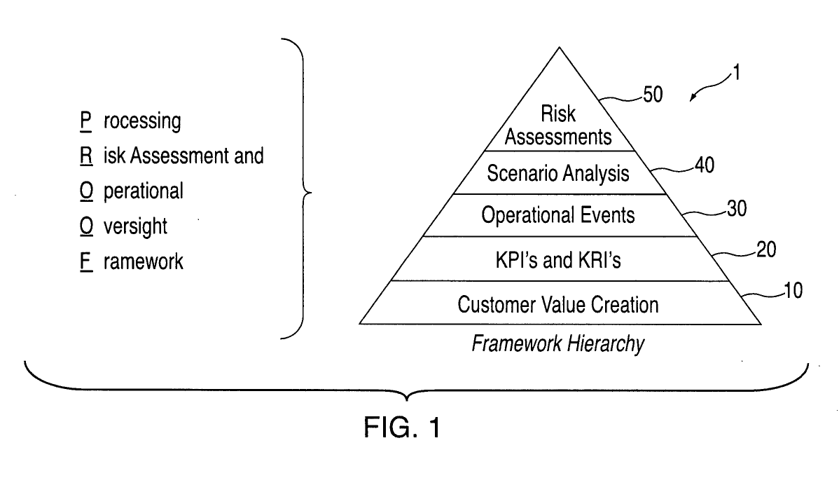

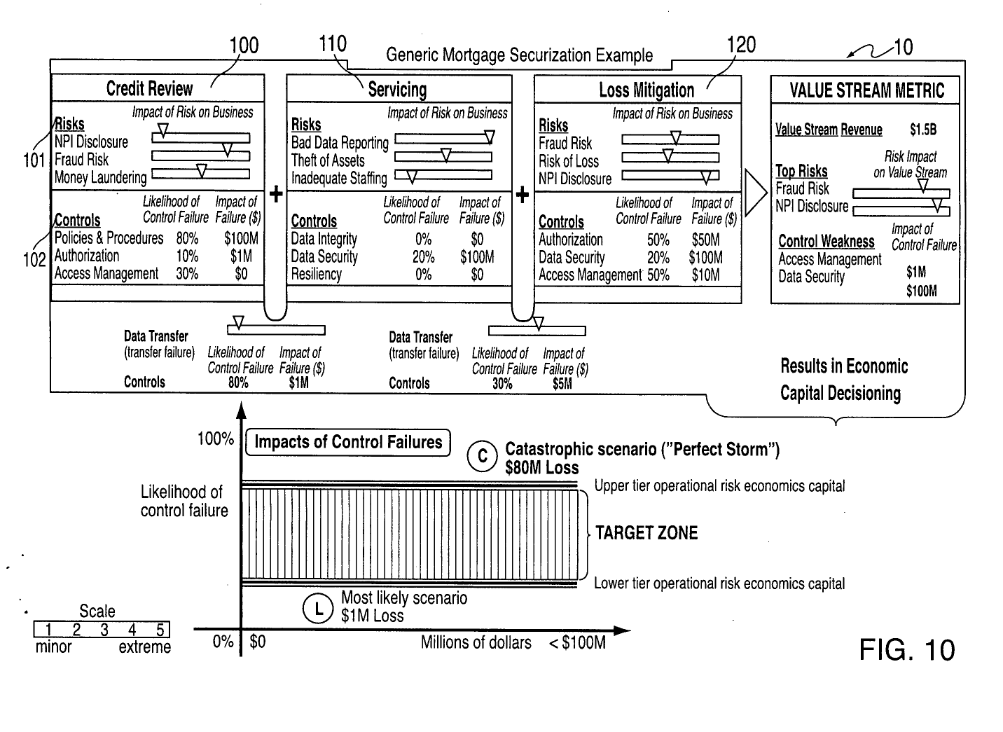

FIGS. 1 through 9 illustrate the apparatus and method for quantifying a business's operational risk exposure through the processing risk assessment and operational oversight framework (“PROOF”) pyramidal hierarchy. FIG. 10 illustrates an example of a generic mortgage securitization process utilizing the PROOF methodology.

Referring now to FIG. 1, the framework hierarchy 1 shows the overall processing risk assessment and operational oversight framework. Within the pyramidal framework hierarchy are numerous levels of steps or building blocks by which risk assessment and risk management are operationally carried out. These framework hierarchy levels include, but are not limited to, the customer value creation continuum level 10, the key performance indicators and key risk indicators level 20, the operational events level 30, the scenario analysis level 40, and the risk assessment level 50. Each level of the framework hierarchy will be herein below explained.

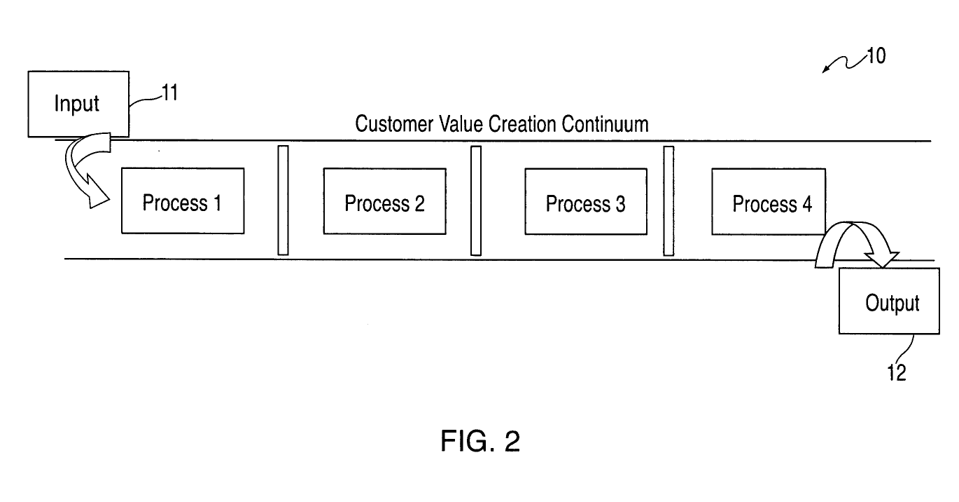

Referring now to FIG. 2, the first step of the customer value creation continuum level 10, the base upon which the PROOF hierarchy is built, is shown. The value creation continuum (or value stream) can be defined as the aggregation of functional activities or business processes of a company that when aligned produce value to the marketplace. For instance, the stream can be shareholder value in terms of products and services that get sold by the company to the marketplace, or the stream can be a company mission statement wherein the mission has value for the company and/or it's clients/customers.

In FIG. 2 several business processes, Process #'s 1 through 4, are shown within the value creation continuum 10. For instance, consider a generic pizza delivery value stream example. The objective of the value stream is to deliver a pizza consistent with customer expectations within 30 minutes. This value stream contains 4 major business processes—Order taking, Order fulfillment, Order delivery and Monetary exchange. Each process has a input criteria 11 and a performance objective output 12. For instance, following the Pizza delivery example the inputs are the customer's order preferences, customer location and method of payment. The output is the Pizza meeting the customer's preferences delivered within the agreed upon timeframe, 30 minutes in the example The fundamental objective of a business process is to maximize operational performance while simultaneously minimizing cost in creating value for customers, while also operating within a targeted level of risk tolerance and in full compliance with regulatory and corporate guidelines. This is the critical connection between value creation, operational business performance, risk, cost and compliance. Using this as a basis, Operational Risk can be defined as the risk that the business process or operation will fail to meet one or more performance objectives in creating value.

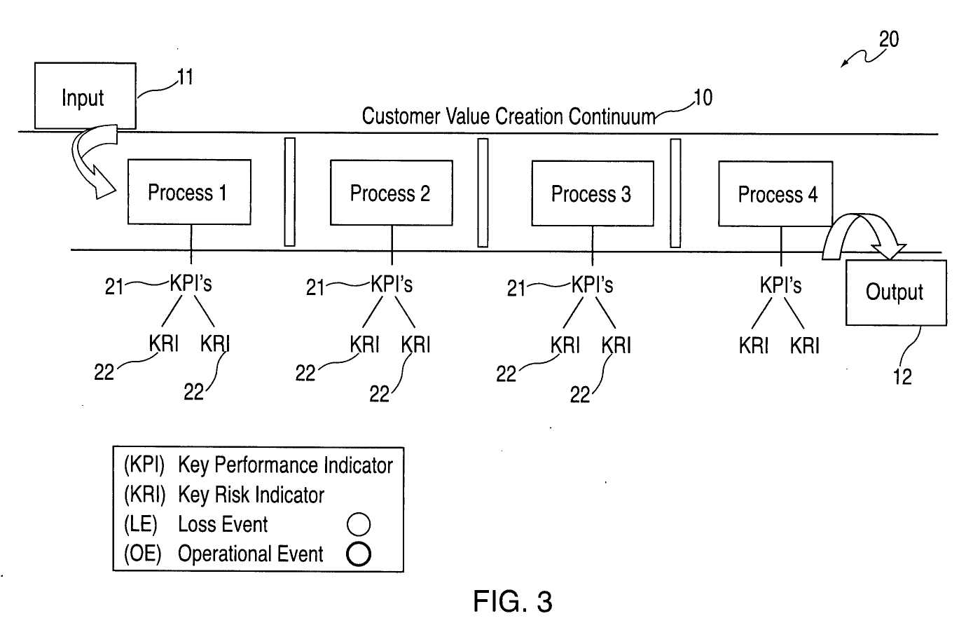

Referring now to FIG. 3, the second step of the PROOF hierarchy is shown with the key performance and key risk indicators level 20. Key Performance Indicators (“KPI”) 21 can be defined as quantitative metrics representing one or more significant business performance objectives. For instance, the % of Pizza's delivered within 30 minutes, and the % of Pizza's delivered meeting customer specifications would be examples of Key Performance Indicators. Additionally, Key Risk Indicators (“KRI”) 22 can be defined as quantifiable measures of the critical success factors to achieving and maximizing those significant business performance objectives. For instance, following the Pizza example, the distance between the customer's home and the Pizza parlor would be a Key Risk Indicator. If the distance exceeds a certain number of miles, the probability of meeting the objective of delivery within 30 minutes will be in jeopardy. By restating the objectives of operational risk management in the language of business performance and customer value creation, Operational Risk becomes an integrated core business function, aligning risk management, improved operational performance and business results.

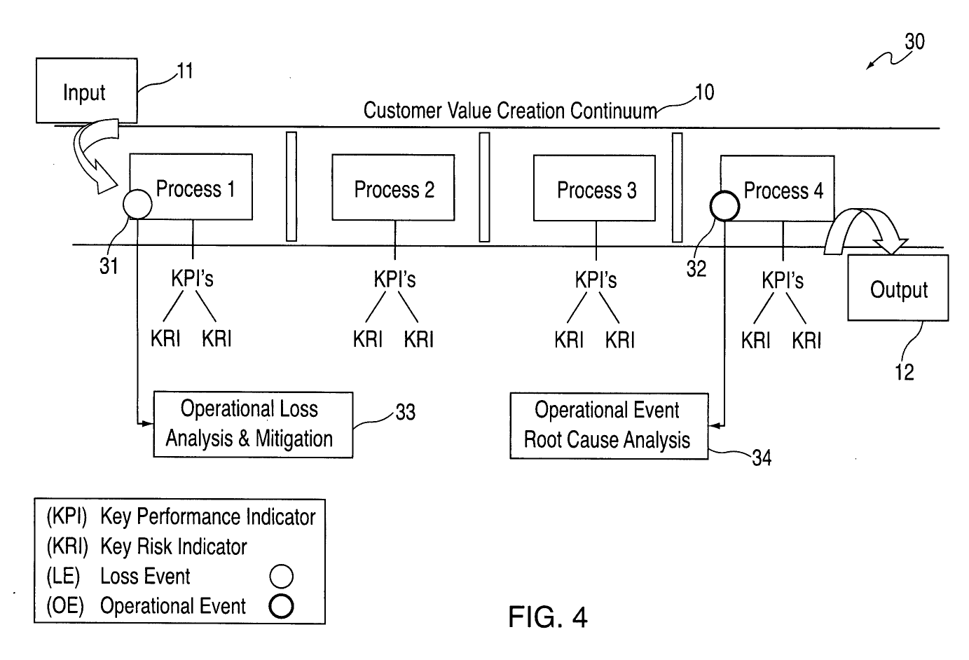

Referring now to FIG. 4, the third step of the PROOF hierarchy is shown with the operational event tracking level 30. Within business process 1, a loss event 31 occurs. For instance, examples of loss events are if the pizza is dropped on the floor or the delivery person gives the client too much change. Likewise, within business process 4, an operation event 32 occurs. For instance, examples of operational events are that the client's order is taken incorrectly (e.g., the wrong toppings), or the pizza is not delivered within 30 minutes. As a result of either a loss event or operational event an operational loss analysis and mitigation event 33 occurs. For instance, for each loss or operational event a strategy would be developed to mitigate the risk or, simply stated, to prevent or minimize the event from occurring. For example, customers can be offered the ability to pay for their pizza using a credit card at the time of their order. This would eliminate the risk of the delivery person providing the incorrect change. Additionally, as a result of such events, a root cause analysis 34 occurs. For instance, an analysis as to why was the customer's order taken incorrectly?, is their a language barrier?, or is their a technical problem with the telephone system?, etc., will be completed. While it is important to track traditional lagging risk indicators, such as actual operational losses, these indicators are most effective when converted to leading risk indicators by including non-financial operational failures that are business impact positive or neutral, such as customer data disclosure leakages or technology failure events.

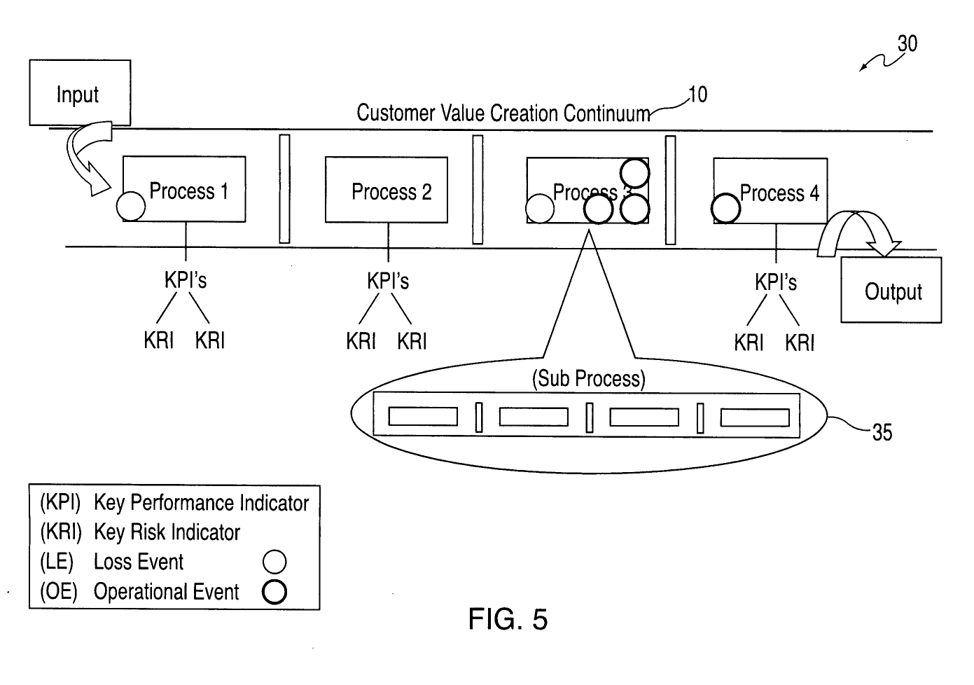

Referring now to FIG. 5, the third step of the PROOF hierarchy is again shown with an event trend analysis. Each particular business process may have a series of control failures associated with it (each identified as an operational event in the figure). Thus it can be considered a failure of operational control when there is a cluster of control failures, as is the case in the figure in business process 3 At this point a deeper review of the sub-processes must be done to figure out where the root cause of the control failures are. By way of example, business process 3 is shown with a sub-process 35. For instance, if a financial company offers variable annuities as a product and thus has a business process in place for effecting such transactions, a sub-process may relate to carrying out such annuity transaction on the basis of verbal instructions from the client. By linking both significant financial and non-financial operational events to their respective business processes and attaching the applicable standardized measures of potential exposure and probability of failure, the elements are in place that when combined with KPI's and KRI's will lead to the creation of meaningful predictive risk models. This approach creates a rational connection between customer value creation and statistical world of operational risk management.

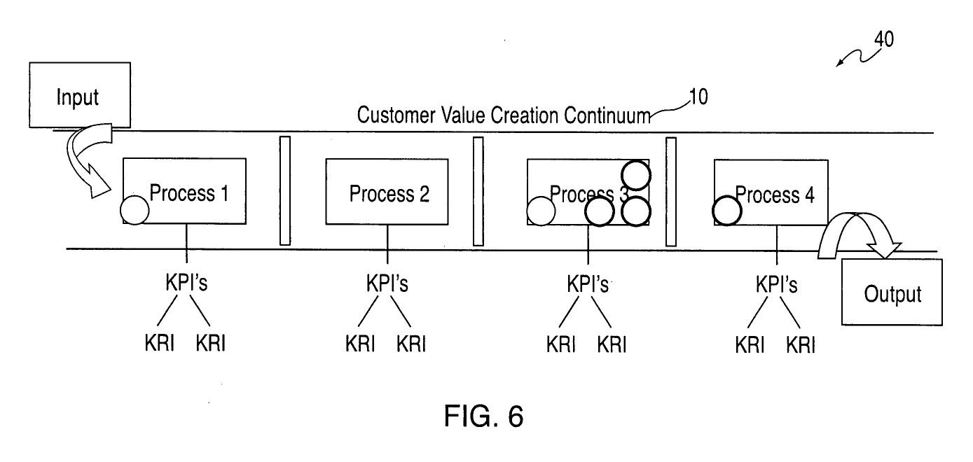

Referring now to FIG. 6, the fourth step of the PROOF hierarchy is shown with the scenario analysis level 40. In this step, each one of the control failures would have a probability of severity assigned to it that would then be used to drive the economic capital to be held in reserve against the business process. Such is accomplished by identifying the operational events in which a control failure has occurred. The history of that control performance is investigated and based on that history a probability of failure is subscribed. For example, should control X by itself fail, it must be determined what is the revenue exposure would be against the value creation continuum stream. In such example if the value creation continuum stream represented equity trading at a company and all of the equity trading resulted in revenue of a billion dollars, and this control happens to be one that makes sure that the order from the customers are right, that the broker has properly solicited the transaction or has proper training of authorization for the account, then failure of that control could result in a charge of unauthorized trading which would then have a huge impact on the revenue stream of the company should the company be sued by a customer. Accordingly, the linkage between the business processes, customer value creation continuum and the statistical elements of operational risk management, provide the foundation for effective Scenario Analysis by identifying those critical components essential to evaluating and quantifying the business exposure to high-severity operational events. Common program attributes include stress testing key performance indicators, key risk indicators, and business process controls identified in the Event Trend Analysis.

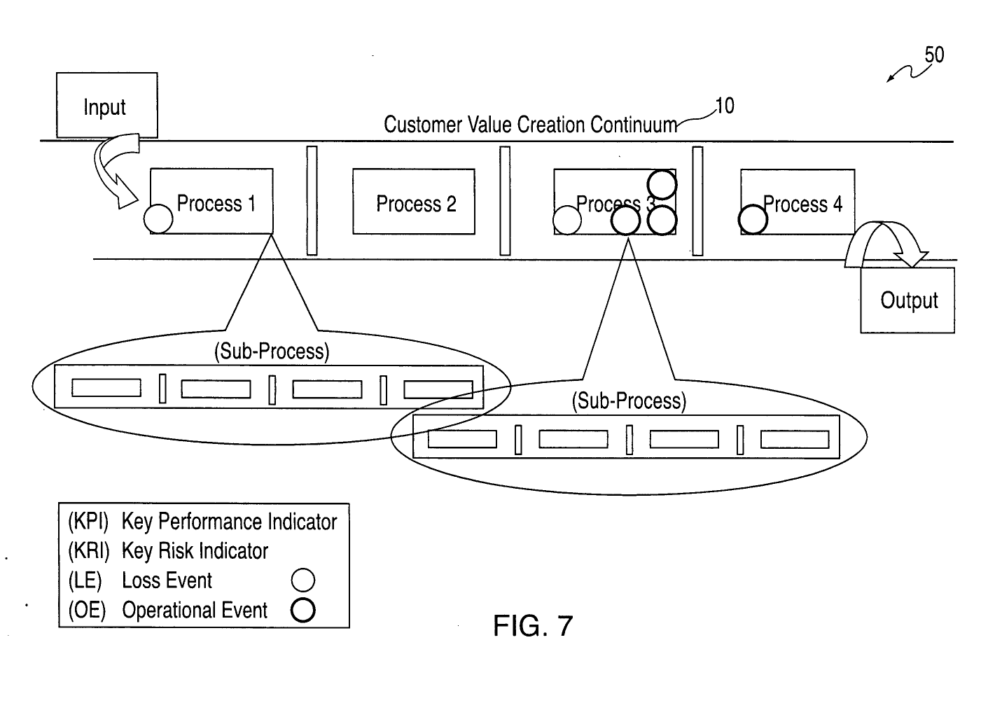

Referring now to FIG. 7, the fifth step of the PROOF hierarchy shows a risk based self-assessment level 50. Traditional risk based self-assessments are subjective, typically conducted at the functional risk management level and largely viewed by business management as a non-value added exercise. However, the present invention's approach creates the platform for an objective and integrated risk based self-assessment that is designed to support ongoing management of the customer value creation continuum and focus business management on those processes with the greatest potential exposure to high-severity operational risk events. According to the present invention, during a risk based self-assessment it is determined whether a control is still the right control to have in place. For instance, questions to be answered include whether the probability of failure has changed, has the control environment improved such that what used to be a manual detective control is now a manual preventative control which reduced the probability of failure or is it now an automated preventative control which would reduce the probability of failure more substantially.

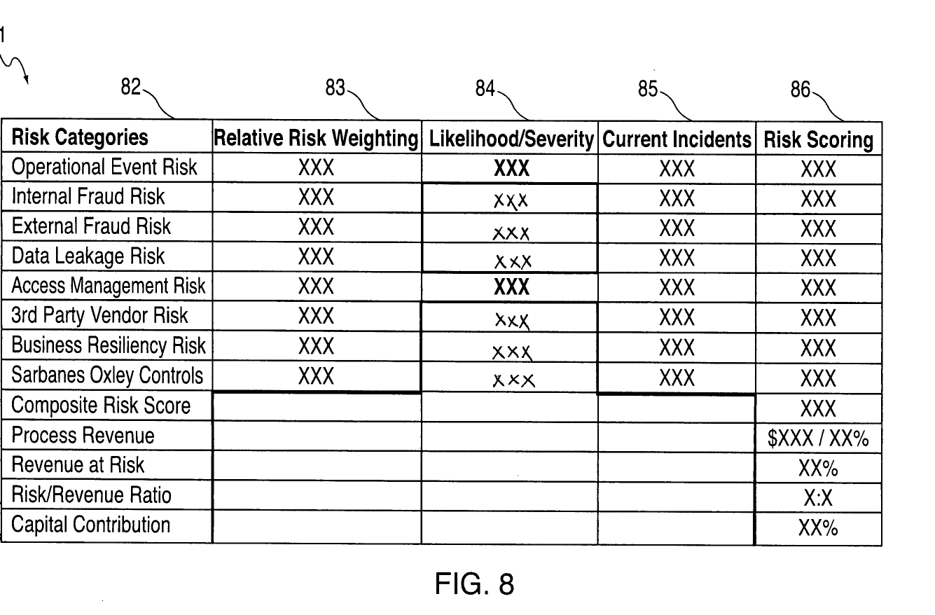

Referring now to FIG. 8, the sixth step of the PROOF hierarchy shows risk scoring. In professional risk assessments, risk combines the probability of an event occurring with the impact that event would have and with its different circumstances. Traditional Operational Risk programs measure key risk in silos, independent from both the value creation continuum and other key risks. The current invention approach measures the aggregated risk associated with the value creation continuum by creating a composite risk score composed of a weighted average of key risk exposure categories and correlates that score to the value created. A scorecard 81 is utilized to figuratively reveal the key risk exposure categories 82. For instance, such risk categories can relate to the risk of customer data leakage or 3^{rd} party vendors. Additionally, categories regarding the relative risk weighting 83, likelihood of severity 84, current incidents 85 are utilized in the computation. The final category, the risk scoring category 86, reveals a risk score for each risk exposure category 82.

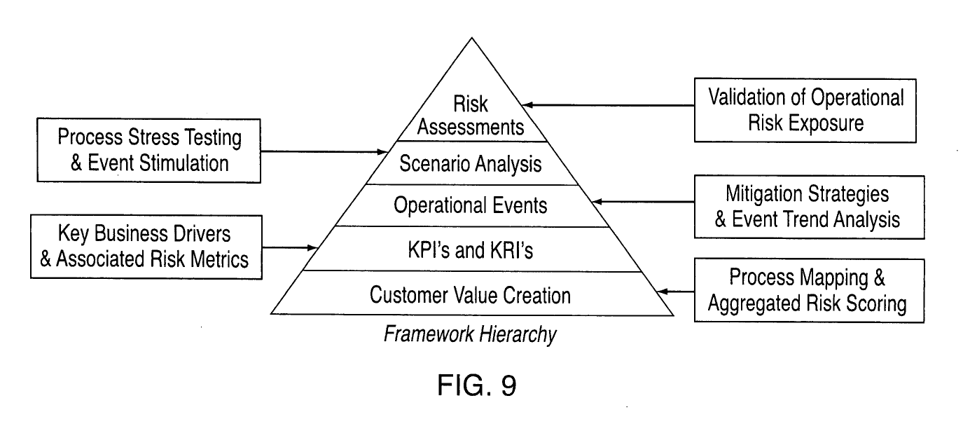

Referring now to FIG. 9, the major events taking place via the PROOF hierarchy described above are shown. For instance, within the customer value creation continuum level 10, process mapping and aggregated risk scoring occur. Within the key performance indicators and key risk indicators level 20, key business drivers and their associated risk metrics are identified. Within the operational events level 30, mitigation strategies are identified and an event trend analysis is undertaken. Within the scenario analysis level 40, process stress testing and event simulation occur. Within the risk assessment level 50 a validation of the operation risk exposure occurs. As such, it is to be understood that each major event is a key risk indicator and/or data collection point that links across the value creation stream and thus builds up as a pyramidal framework allowing for a calculation of the operational risk capital that should be set aside. This alleviates the problem that risk management faces, that of allocating resources. Essentially, this is the idea of opportunity cost, that resources spent on risk management could have been spent on more profitable activities.

Accordingly, as shown by the above description, through use of the PROOF hierarchy the operational risk exposure to any organization is evaluated by looking at various value streams that the organization utilizes or has to create value for and/or in the marketplace, identifying the critical risk points within that value stream, and then assessing the risk of catastrophic incident on the value stream. In looking at each one of the individual risk points in the value stream, a likelihood of failure and a worse case scenario are attributed for each one of the individual risk points. Such can be accomplished utilizing a “Monte Carlo” type simulation to determine the probabilities of what the worse case scenario is and what the revenue impact is from that worse case scenario, and what the most likely scenario to occur is and what the revenue impact is on that case scenario. Such numbers can then be aggregated across all of the value streams a company may have to determine what the capital calculation should be for operational risk and what capital should be held against such scenarios. By way of further explanation, an example will be utilized below.

Referring now to FIG. 10, a generic mortgage securitization example in which a value stream risk analysis drives an operation risk economic capital decision process is shown. Using value stream mapping analysis, a visual map of how products, information and resources flow through a business to deliver value to the customer, that is the major components of the Mortgage Securitization process, are identified. Each step in the creation of value begins with a set of inputs, followed by a process to transform those inputs and produce a set of outputs for the customer of the sub-process.

In the example, in a Credit Review business process 100 a portfolio of individual loans is received as input. Such individual loans are evaluated based on FICO scores and other metrics to determine the probability of default. This then produces an output of whether those loans meet a desired risk profile. Within this process there are a number of operational risks 101 present and a set of corresponding controls 102 to manage the risks. For example, the risk of the disclosure of non-public information (NPI) is relatively low, while the potential risk of mortgage fraud is very high. Likewise, each control has a probability of failure based on historical performance and an associated impact of failure. In the example, the likelihood of a failure to follow documented policies and procedures is 80% with a potential impact of $100 million.

These steps are then repeated for each major component of the value creation stream continuum. In the example Servicing process 110 and Loss Mitigation process 120 are evaluated next. The following steps are then followed in each sub-process: 1) Identify the significant operational risks; 2) Identify the major controls; 3) Determine the probability for control failure based on historical performance or industry data; and 4) Determine potential impact of the individual control failure (severity). While each operational risk and control may be important individually, it is the aggregate impact on the value stream continuum that is the determining factor for the level of operational risk economic capital that should be held to protect customers and shareholders from catastrophic failures.

Once the value stream mapping exercise is completed, the data elements are input into the “Operational Risk Value Stream Based Capital Calculation” formula:

PFI=AR*{max[Pr(FCM:1−n)]+max[Pr(FOU:1−n)]+max[Pr(FAD:1−n)]+max[Pr(FSD:1−n)]+max[Pr(FS:1−n)]}; and

MLFS=--------, where Fk is the maximum probability of failure for any number of links in a value chain.

The variables in the formula are defined as follows:
PFI=projected financial impact of most likely failure scenario across the value stream;
AR=annual Value Stream revenue;
Pr(FCM:1)=probability of failure in the customer mgmt link of the value stream due to the 1st control;
Pr(FCM:2)=probability of failure in the customer mgmt link of the value stream due to the 2nd control;
Pr(FCM:n)=probability of failure in the customer mgmt link of the value stream due to the nth control;
max[Pr(FCM:n)]=maximum of all probability failures the customer mgmt link of the value stream;
Pr(FOU)=probability of failure in the origination/underwriting link of the value stream;
Pr(FAD)=probability of failure in the acquisition/delivery link of the value stream;
Pr(FSD)=probability of failure in the securitization/distribution link of the value stream;
Pr(FS)=probability of failure in the servicing link of the value stream; and
MLFS=most likely failure scenario to occur at each link throughout the value stream.

Referring back to FIG. 10, in the example the scenario of control failures with the highest probability of occurrence would result in a potential loss of $1 million in revenue. This represents the minimum amount of operational capital to be held for this value stream continuum. The scenario which results in the greatest potential loss would result in a loss of $80 million in revenue. This is the referred to as the “perfect storm” scenario. While this has the highest potential financial impact, the probability of occurrence is minimal (0.0000000023%). The two revenue numbers represent the lower and upper tier for Operational Risk Based Capital.

In the foregoing description, the method and apparatus of the present invention have been described with references to specific examples. It is to be understood and expected that variations in the principles of the method and apparatus herein disclosed may be made by one skilled in the art and it is intended that such modifications, changes, and substitutions are to be included within the scope of the present invention as set forth in the appended claims. The specification and the drawings are accordingly to be regarded in an illustrative rather than in a restrictive sense.

What is claimed is:

1. A method for identifying and mitigating operational risk exposure to an organization, the method comprising the steps of:
identifying the organization's value creation continuum;
identifying at least one Key Performance Indicator within the organization's value creation continuum;
identifying at least one Key Risk Indicator within the organization's value creation continuum;
conducting an operational loss analysis and mitigation in response to a loss event or an operation event occurring within the organization's value creation continuum;
conducting a root cause analysis to determine a cause of the loss event or the operation event that occurred within the organization's value creation continuum;
conducting an event trend analysis in response to a cluster of operation events occurring within the organization's value creation continuum;
conducting a scenario analysis to assign a probability of severity to each of the operation events occurring within the organization's value creation continuum; and
conducting a risk based self-assessment to determine whether a control is still the right control to have in place within the organization's value creation continuum,
wherein each of the above steps allows for a link across the organization's value creation continuum so that a calculation of the operational risk capital that should be set aside can be made.

2. The method according to claim 1, wherein the step of identifying the organization's value creation continuum comprises the step of:
identifying at least one functional activity or business process of the organization that when aligned with at least one other functional activity or business process of the organization produce value to a marketplace.

3. The method according to claim 1, wherein the at least one Key Performance Indicator is a quantitative metric representing at least one significant business performance objective of the organization.

4. The method according to claim 1, wherein the at least one Key Risk Indicator is a quantifiable measure representing at least one critical success factor to achieving and maximizing at least one significant business performance objective of the organization.

5. The method according to claim 1, wherein the step of conducting an event trend analysis in response to a cluster of operation events occurring within the organization's value creation continuum comprises the step of:
identifying at least one functional sub-activity or business sub-process of the at least one functional activity or business process of the organization.

6. The method according to claim 1, wherein the step of conducting a scenario analysis to assign a probability of severity to each of the operation events occurring within the organization's value creation continuum comprises at least one of the steps of:
identifying at least one operation event in which a control failure has occurred;
investigating a history of control performance within the control failure; and
subscribing a probability of failure to the control performance.

7. A method for quantifying a business's operational risk exposure through a processing risk assessment and operational oversight framework hierarchy, the method of the framework hierarchy comprising the steps of:
mapping at least one process within a value creation stream;
aggregating a risk scoring within the value creation stream;
identifying at least one key business driver as a key performance indicator;
identifying at least one associated risk metric for the at least one key business driver as a key risk indicator;
identifying at least one mitigation strategy for at least one operational event;
undertaking an event trend analysis for at least one operational event;
conducting process stress testing within a scenario analysis;
conducting an event simulation within the scenario analysis; and
validating the operation risk exposure as part of a risk assessment,
wherein each step is a data collection point that links across the value creation stream and thus allows for a calculation of the operational risk capital that should be set aside.
